(19) United States
(12) Patent Application Publication
(10) Pub. No.: US 2007/0288209 A1
(43) Pub. Date: Dec. 13, 2007

(54) CAD system, shape correcting method and computer-readable storage medium having recorded program thereof

(75) Inventor: Haruyasu Watanabe, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/542,170

(22) Filed: Oct. 4, 2006

(30) Foreign Application Priority Data
Jun. 12, 2006 (JP) 2006-162661

(51) Int. Cl. G06F 17/10

(52) U.S. Cl. 703/2

(57) ABSTRACT

The present invention comprises a step detecting section for detecting a micro-step smaller than the tolerance value on a construction plane of a shape model, which is set at a predetermined interval so as to be identical to a tolerance value set up in a shape model; a correction object detecting section for detecting an object portion to be corrected in the shape model based on a positional relationship between an end portion constituting the micro-step and intersection of reference lines disposed in a grid pattern; and a step eliminating section for eliminating the micro-step on construction planes of the shape model by changing the shape of the shape model relevant to the object portion to be corrected. By eliminating the micro-step in the shape model, the number of working steps for exchanging modeling data can be reduced while maintaining the quality of a product.

### BACKGROUND OF THE INVENTION

1) Field of the Invention

The present invention relates to a CAD system, a shape correcting method and a computer-readable storage medium having a shape correction program recorded thereon suitably used for correcting a shape of a shape model disposed in a virtual space formed with a plurality of reference lines disposed in a grid pattern keeping a predetermined interval.

2) Description of the Related Art

Recently, CAD (Computer Aided Design) systems are widely used in the field of product designing. For example, a shape under examination or being imagined by a designer can be achieved as a shape model, which is defined by three-dimensional modeling data (hereinafter, referred to as shape model) in a virtual space formed by a computer by using a three-dimensional CAD system. Such three-dimensional CAD systems are now commercialized in a wide range from a high function and high price model to a low price model.

Also, such data relevant to a shape model created with a three-dimensional CAD system (hereinafter, occasionally referred to as modeling data) are generally used for examining a shape of the shape model by using the data in a CAE (Computer Aided Engineering) system before creating a pre-production sample; or a die assembly is created swiftly by using the data in a CAM (Computer Aided Manufacturing) system.

FIG. 12 illustrates a conventional process to convert three-dimensional modeling data into an intermediate file for data exchange.

When modeling data created with a three-dimensional CAD system (writing side) are used on another three-dimensional CAD, CAE, CAM system or the like (receiving side) and when the types of three-dimensional CAD systems capable of handling the data are different from each other between the writing side and the receiving side, the three-dimensional modeling data (modeling data) have to be converted once into a format, which is generally called an intermediate file, at the writing side as shown in FIG. 12, and then the intermediate file has to be transferred to the receiving side. The following standards are generally applied to the intermediate file; i.e., for example, STEP (Standard for the exchange of product model data), IGES (Initial Graphics Exchange Specification), DXF (Drawing Interchange File) and Parasolid (registered trademark).

Now, when data are transferred from the writing side to the receiving side, some problem occasionally occurs during data exchanging due to the difference in tolerance value or structure of internal data in the respective CAD systems.

Here, the wording “tolerance value” means a threshold value for determining, when end points constituting the shape model are disposed being away from each other (case of not zero), whether the two end points are jointed or away from each other. For example, when the tolerance value is set to 1/1000 mm, and if the distance between the two end points is 1/1000 mm or less, the two end points are determined as being jointed.

Ordinarily, the tolerance value can be arbitrarily set, and is often set uniquely based on the conditions such as a shape of a product and a necessary tolerance. Further, the handling manner of data smaller than the tolerance value is different from each other depending on the type of the three-dimensional CAD system. For example, in such a case that the types of the three-dimensional CAD systems are different from each other between the writing side and the receiving side, and when such an input to create a shape having a dimension smaller than the tolerance value is made at the writing side, at the receiving side, the shape of a dimension smaller than the tolerance value may be occasionally generated or may not be generated in the shape model that is transferred from the writing side.

Therefore, in the shape model, for example, even when it is created as one construction plane at the writing side, in the case that a step smaller than the tolerance value (hereinafter, simply referred to as micro-step) is actually included in the construction plane, there may occur such a disadvantage at the receiving side that the construction plane may be divided or recognized as a portion at which edges are cut off in its half way.

FIG. 13 is a perspective view showing an example of a shape model including a micro-step.

When a micro-step 92 is included in construction planes 91a and 91b constituting a shape model 90 as shown in FIG. 13, some three-dimensional CAD systems display a line 93 representing the micro-step 92 in the construction planes 91a and 91b on its screen. In such a case, the micro-step 92 may be occasionally found by visual check. However, the micro-step 92 is hardly detected using a general function such as geometric check included in three-dimensional CAD system. When such micro-step 92 is not displayed on the screen or recognized visually, the micro-step 92 on the construction planes 91a and 91b cannot be detected.

Further, when a product is manufactured based on the shape model in a state such a micro-step is included, a micro-step, which is unintended by a designer, might be generated on the surface of the product itself.

In addition, in order to prevent such problem from occurring, either one of the writing side and the receiving side has to carry out a work to eliminate the micro-step. Particularly, when many micro-steps are included, much time has to be taken for the work to eliminate the micro-steps resulting in an increase of load on an operator.

Therefore, it is a large problem at the designing stage of a product to achieve data conversion without causing such a problem due to the micro-step as described above. So far, various techniques as described below have been disclosed.

For example, the following patent document 1 discloses a technique to eliminate a conversion error, which is caused by a geometrical calculation error arising as a problem independent of the format during data conversion between arbitrary formats of three-dimensional CAD systems.

Additionally, the following patent document 2 discloses a technique to detect a gap between curvature portions, which should be abutted on each other, but the boundary lines are separated from each other slightly larger than the tolerance error of systems.

Moreover, the following patent document 3 discloses a technique; i.e., a portion having multiple lines overlapped is automatically detected from inputted graphic data and converted into data of single line; and further, yet-to-be-jointed portions within a predetermined range of distance are jointed to each other, and the yet-to-be-jointed portions out of the predetermined range of distance are displayed.

### [Patent document 1] Japanese Patent Laid-Open (Kokai) No. 2000-011013

### [Patent document 2] Japanese Patent Laid-Open (Kokai) No. 2004-110285

[Patent document 3] Japanese Patent Laid-Open (Kokai) No. HEI 06-259121

However, in the above-described patent document 1, a tolerance value, which is a necessary condition to prevent the conversion error in the converted data, is estimated and set to an optimum value to eliminate the conversion error. However, the micro-step itself cannot be eliminated.

Also, in the above patent document 2, only the gaps slightly larger than the tolerance value are detected. In the above patent document 3, since only the yet-to-be-jointed portions are jointed to each other, the micro-step itself cannot be eliminated same as above.

### SUMMARY OF THE INVENTION

The present invention has been proposed in view of the above-described problems. It is an object of the present invention to provide a CAD system, a shape correcting method and a computer-readable storage medium having recorded a program thereof, which are capable of eliminating micro-steps in a shape model and thereby reducing the number of works during exchanging modeling data for a shape model while maintaining the quality of the product.

In order to achieve the above object, a CAD system according to the present invention is a CAD system handling a shape model on a virtual space in which a plurality of reference lines is formed in a grid pattern keeping a predetermined interval, the predetermined interval being set so as to be identical to a tolerance value set in the shape model, the CAD system comprises: a step detecting section for detecting a micro-step smaller than the tolerance value on a construction plane of the shape model; a correction object detecting section for detecting an object portion to be corrected in the shape model based on a positional relationship between an end portion constituting the micro-step detected by the step detecting section and an intersection of the reference lines disposed in a grid pattern; and a step eliminating section for eliminating a micro-step on the construction plane of the shape model by changing the shape of the shape model relevant to the object portion to be corrected detected by the correction object detecting section.

The correction object detecting section preferably detects an end portion, which is not positioned on the intersection of the reference lines disposed in a grid pattern, among the end portions constituting the micro-step, and detects the construction plane including the relevant end portion as the object portion to be corrected.

The correction object detecting section preferably detects an end portion, which is not positioned on the intersection of the reference lines disposed into a grid pattern based on coordinate values of the end portion constituting the micro-step and detects the construction plane including the relevant end portion as the object portion to be corrected.

The step eliminating section may replace the object portion to be corrected with a plane, which coincides with a portion different from the relevant object portion to be corrected among the portions constituting the micro-step, and thereby eliminate the micro-step on the construction plane of the shape model.

The step eliminating section may replace a plurality of portions including the object portion to be corrected with portions not including the micro-step, and thereby eliminate the micro-step on the construction plane of the shape model.

There may be provided an alarm output section for outputting an alarm when the end portion constituting the micro-step detected by the step detecting section is located at an undesirable position with respect to the intersections of the reference lines disposed in a grid pattern.

A shape correcting method according to the present invention is a shape correcting method of a shape model disposed on a virtual space in which a plurality of reference lines is formed in a grid pattern keeping a predetermined interval set so as to be identical to a tolerance value, the method comprises: a step detecting step detecting a micro-step smaller than the tolerance value on a construction plane of the shape model; a correction object detecting step detecting an object portion to be corrected in the shape model based on a positional relationship between an end portion constituting the micro-step detected in the step detecting step and an intersection of the reference lines disposed in a grid pattern; and a step eliminating step eliminating the micro-step on the construction plane of the shape model by changing the shape of the shape model relevant to the object portion to be corrected detected in the correction object detecting step.

In the correction object detecting step, an end portion which is not positioned on the intersection of the reference lines disposed in a grid pattern among the end portions constituting the micro-step is preferably detected, and a construction plane including the relevant end portion is preferably detected as the object portion to be corrected.

In the correction object detecting step, an end portion which is not positioned on the intersection of the reference lines disposed in a grid pattern is preferably detected based on coordinate values of the end portion constituting the micro-step, and the construction plane including the relevant end portion is preferably detected as the object portion to be corrected.

In the step eliminating step, the object portion to be corrected may be replaced with a plane, which coincides with a portion different from the relevant object portion to be corrected among the portions constituting the micro-step, and thereby the micro-step on the construction plane of the shape model may be eliminated.

In the step eliminating step, a plurality of portions including the object portion to be corrected may be replaced with portions not including the micro-step, and thereby the micro-step on the construction plane of the shape model may be eliminated.

There may be included an alarm outputting step outputting an alarm when the end portion constituting the micro-step detected in the step detecting step is located at an undesirable position with respect to the intersection of the reference lines disposed in a grid pattern.

A computer-readable storage medium having a shape correction program according to the present invention is a computer-readable storage medium having a shape correction program recorded thereon causing a computer to execute a shape correction function of a shape model disposed on a virtual space, in which a plurality of reference lines is formed in a grid pattern keeping a predetermined interval set so as to be identical to a tolerance value, the shape correction program causing the computer to execute: a step detecting step detecting a micro-step smaller than the tolerance value on a construction plane of the shape model; a correction object detecting step detecting an object portion to be corrected in the shape model based on a positional relationship between an end portion constituting the micro-step detected in the step detecting step and an intersection of the reference lines disposed in a grid pattern; and a step eliminating step eliminating the micro-step on the construction plane of the shape model by changing the shape of the shape model relevant to the object portion to be corrected detected in the correction object detecting step.

The shape correction program, when causing the computer to execute the correction object detecting step, preferably allows the computer to realize a function of detecting an end portion which is not positioned on the intersection of the reference lines disposed in a grid pattern among the end portions constituting the micro-step, and to detect a construction plane including the relevant end portion as the object portion to be corrected.

The shape correction program, when causing the computer to execute the correction object detecting step, preferably allows the computer to realize a function of detecting an end portion which is not positioned on the intersection of the reference lines disposed in a grid pattern based on coordinate values of the end portion constituting the micro-step, and preferably detects the construction plane including the relevant end portion as the object portion to be corrected.

The shape correction program may, when causing the computer to execute the step eliminating step, allow the computer to realize a function of replacing the object portion to be corrected with a plane which coincides with a portion different from the relevant object portion to be corrected among the portions constituting the micro-step, and thereby eliminate the micro-step on the construction plane of the shape model.

The shape correction program may, when causing the computer to execute the step eliminating step, allow the computer to realize a function of replacing a plurality of portions including the object portion to be corrected with portions not including the micro-step, and thereby eliminate the micro-step on the construction plane of the shape model.

The shape correction program may cause the computer to execute an alarm outputting step outputting an alarm when the end portion constituting the micro-step detected in the step detecting step is located at an undesirable position with respect to the intersection of the reference lines disposed in a grid pattern.

According to the present invention, the micro-step is eliminated in the following steps; i.e., the micro-step smaller than the tolerance value on the construction plane of the shape model is detected first, then the object portion to be corrected in the shape model is detected, and finally the shape of the shape model relevant to the object portion to be corrected is changed. Accordingly, a step to detect and eliminate the micro-step, which has been conventionally carried out by an operator, can be eliminated.

Accordingly, in the case where many micro-steps smaller than the tolerance value are included in the shape model, the working load imposed upon the operator can be largely reduced.

Also, since a designer or the like do not have to manually carry out shape correction of the shape model, the number of works for exchanging the modeling data relevant to the shape model can be reduced.

Moreover, the micro-step on the construction plane of the shape model is eliminated by changing the shape of the shape model relevant to the detected object portion to be corrected. Therefore, modeling data, which do not include data smaller than the tolerance value such as micro-step, can be generated.

That is, since the micro-step itself is eliminated from the shape model, even when the shape model is handled on a tool in the following process, which handles the tolerance value in a different manner, no problem due to the micro-step occurs, thus increasing convenience.

Moreover, an end portion, which does not position on the intersection of the reference lines disposed in a grid pattern among the end portions constituting the micro-step, is detected, and then the construction plane including the end portion is detected as the object portion to be corrected. Therefore, the construction plane being the cause to constitute the micro-step can be detected easily and correctly. Thus, the object portion to be corrected can be detected swiftly.

Moreover, since the object portion to be corrected is detected based on the coordinate values of the end portion constituting the micro-step, the end portion being the cause to constitute the micro-step can be detected swiftly and precisely.

### BRIEF DESCRIPTION OF THE DRAWINGS

FIG. 1 is a block diagram showing a hardware configuration of a CAD system as an embodiment of the present invention;

FIG. 2 is a perspective view of a shape model for illustrating the detection process of a micro-step by a step detecting section of the CAD system as the embodiment of the present invention;

FIG. 3 is a side view of the shape model for illustrating the detection process of a correction object by a correction object detecting section of the CAD system as the embodiment of the present invention;

FIG. 4 is a perspective view of the shape model for illustrating the detection process of the correction object by the correction object detecting section of the CAD system as the embodiment of the present invention;

FIG. 5 is a side view of a shape model for illustrating the elimination process of a micro-step by a step eliminating section of the CAD system as the embodiment of the present invention;

FIG. 6 is a perspective view of the shape model showing a state that the micro-step has been eliminated by the step eliminating section of the CAD system as the embodiment of the present invention;

FIG. 7 is a side view of a shape model showing a state in which an alarm is outputted by an alarm output section of the CAD system as the embodiment of the present invention;

FIG. 8 is a flowchart showing the operation steps to eliminate a micro-step formed in the shape model by the CAD system as the embodiment of the present invention;

FIG. 9(a-1) is a side view of a shape model for illustrating the detection process of a correction object by the correction object detecting section of the CAD system as the embodiment of the present invention;

FIG. 9(a-2) is a side view of the shape model for illustrating the elimination process of the micro-step by the step eliminating section of the CAD system as the embodiment of the present invention;

FIG. 10(a-1) is a side view of a shape model for illustrating the detection process of a correction object by the correction object detecting section of the CAD system as the embodiment of the present invention;

FIG. 10(a-2) is a side view of the shape model for illustrating the elimination process of the micro-step by the step eliminating section of the CAD system as the embodiment of the present invention;

FIG. 10(b-1) is a side view of a shape model for illustrating the detection process of a correction object by the correction object detecting section of the CAD system as the embodiment of the present invention;

FIG. 10(b-2) is a side view of the shape model for illustrating the elimination process of the micro-step by the step eliminating section of the CAD system as the embodiment of the present invention;

FIG. 11(a-1) is a side view of a shape model for illustrating the detection process of a correction object by the correction object detecting section of the CAD system as the embodiment of the present invention;

FIG. 11(b-1) is a side view of a shape model for illustrating the detection process of a correction object by the correction object detecting section of the CAD system as the embodiment of the present invention;

FIG. 11(c-1) is a side view of a shape model for illustrating the detection process of a correction object by the correction object detecting section of the CAD system as the embodiment of the present invention;

FIG. 11(d-1) is a side view of a shape model for illustrating the detection process of a correction object by the correction object detecting section of the CAD system as the embodiment of the present invention;

FIG. 11(a-2) is a side view of the shape model for illustrating the elimination process of a micro-step by the step eliminating section of the CAD system as the embodiment of the present invention;

FIG. 11(b-2) is a side view of the shape model for illustrating the elimination process of a micro-step by the step eliminating section of the CAD system as the embodiment of the present invention;

FIG. 11(c-2) is a side view of the shape model for illustrating the elimination process of a micro-step by the step eliminating section of the CAD system as the embodiment of the present invention;

FIG. 11(d-2) is a side view of the shape model for illustrating the elimination process of a micro-step by the step eliminating section of the CAD system as the embodiment of the present invention;

FIG. 12 is a diagram for illustrating a conventional processing to convert three-dimensional modeling data into an intermediate file for exchanging the data; and

FIG. 13 is a perspective view showing an example of a shape model including a micro-step.

### DESCRIPTION OF THE PREFERRED EMBODIMENTS

Hereinafter, embodiments of the present invention will be described with reference to the drawings.

### [1] Description of an Embodiment of the Present Invention

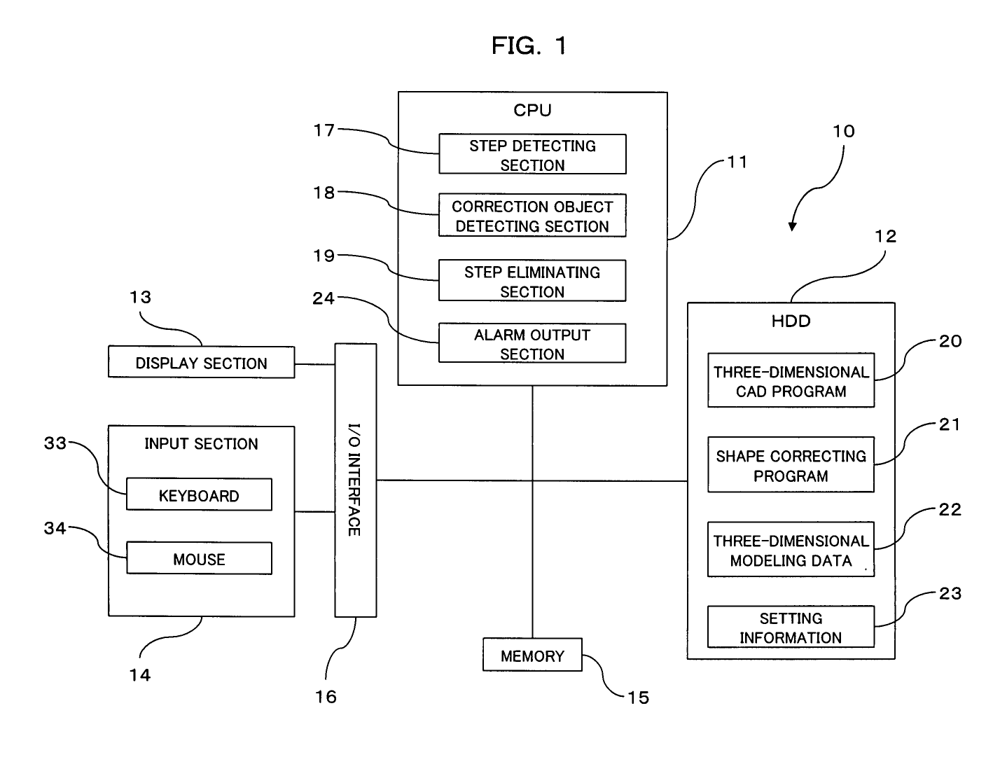

FIG. 1 is a block diagram showing a hardware configuration of a CAD system as an embodiment of the present invention.

A CAD (Computer Aided Design) system 10 according to the embodiment is configured as a computer system including a CPU (Central Processing Unit) 11, an HDD (Hard disk drive) 12, a display section 13, an input section 14 and a memory 15 as shown in FIG. 1. Also, the display section 13 and the input section 14 are connected to the CPU 11, HDD 12 and memory 15 through an I/O interface 16.

The CPU 11 performs various numerical calculations, information processing, device control and the like in the CAD system 10. In this embodiment, the CPU 11 is adapted to function as a step detecting section 17, a correction object detecting section 18, a step eliminating section 19 and an alarm output section 24 as described later.

The HDD 12 is storage for storing various programs including various data and OS (Operating System). In this embodiment, the HDD 12 stores a three-dimensional CAD program 20, a shape correction program 21, a three-dimensional modeling data 22 and setting information 23.

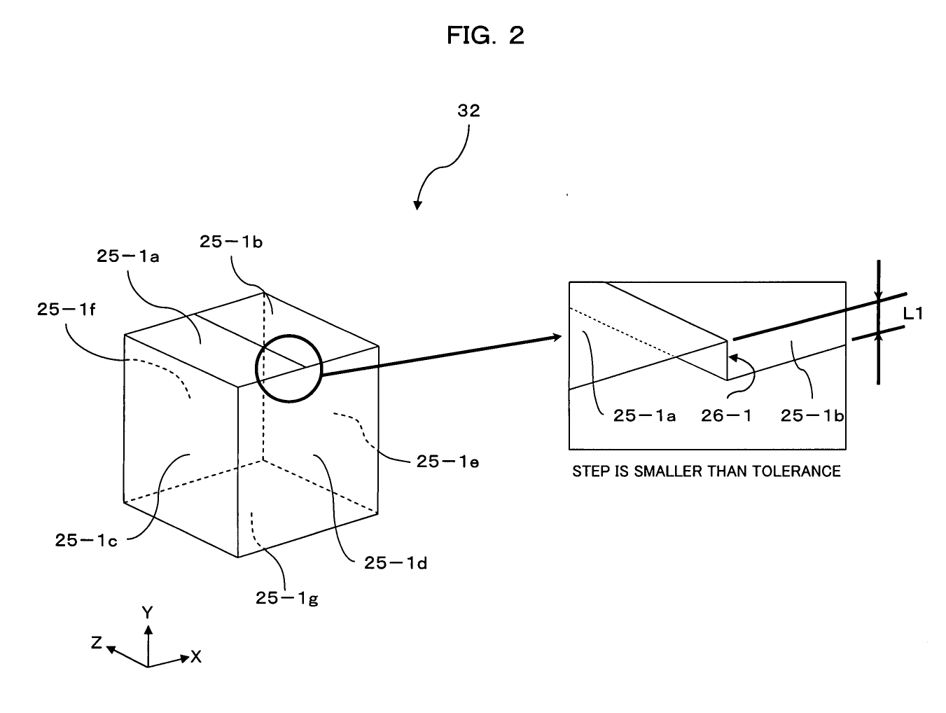

The three-dimensional modeling data 22 are data for defining a three-dimensional shape model (hereinafter, referred to as shape model) 32 (refer to FIG. 2).

The three-dimensional CAD program 20 is an application program for handling the three-dimensional shape model 32 on a virtual space. For example, the three-dimensional CAD program 20 has a function to create the shape model 32 and a function to change/correct the shape of the shape model 32 and the like.

The shape correction program 21 is a program for correcting the shape of the shape model 32. For example, in order to eliminate a micro-step formed in the shape model 32, the shape correction program 21 is adapted so as to achieve the functions as the step detecting section 17, the correction object detecting section 18, the step eliminating section 19 and the alarm output section 24, as described later.

The setting information 23 is information, which is set to handle the shape model 32 using the three-dimensional CAD program 20, and for example, information about grid lines, tolerance values and the like are set therein.

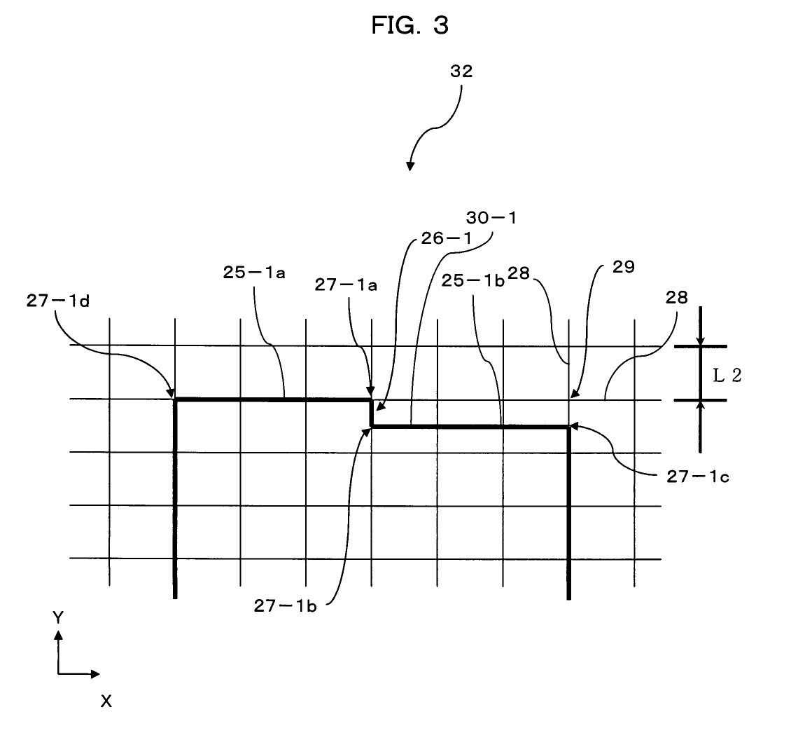

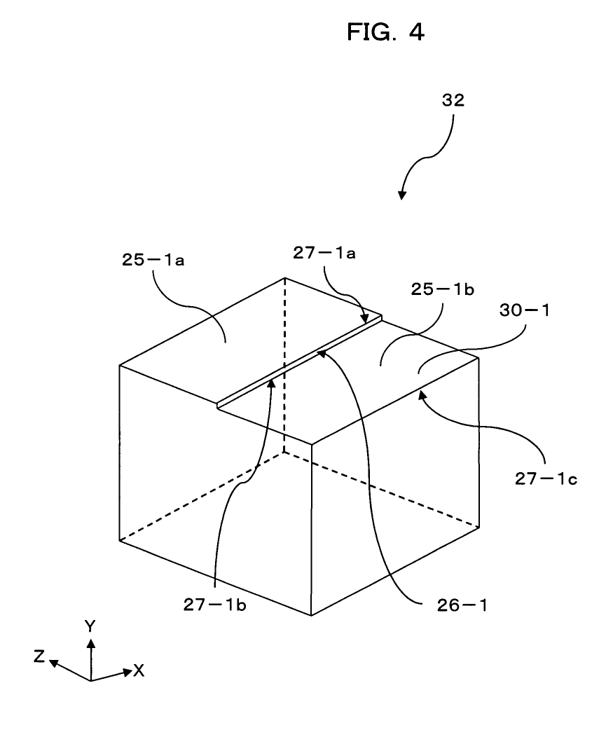

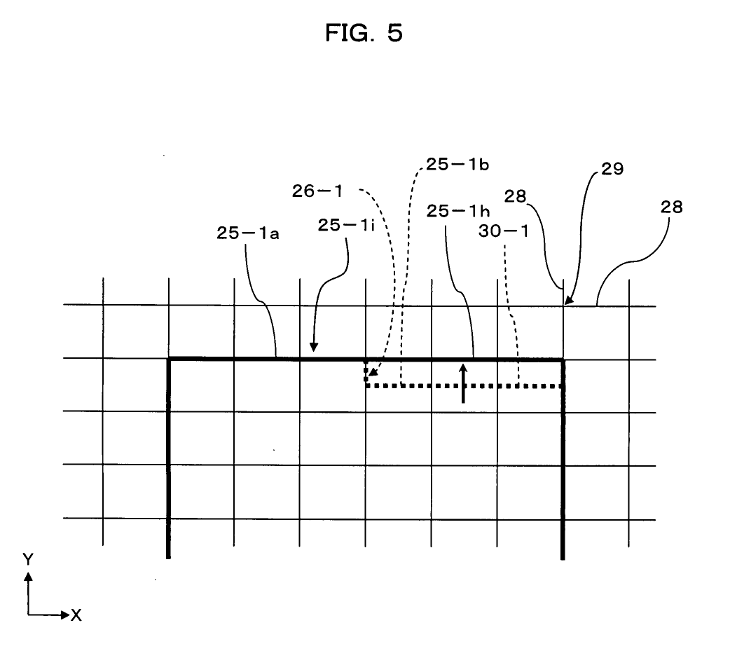

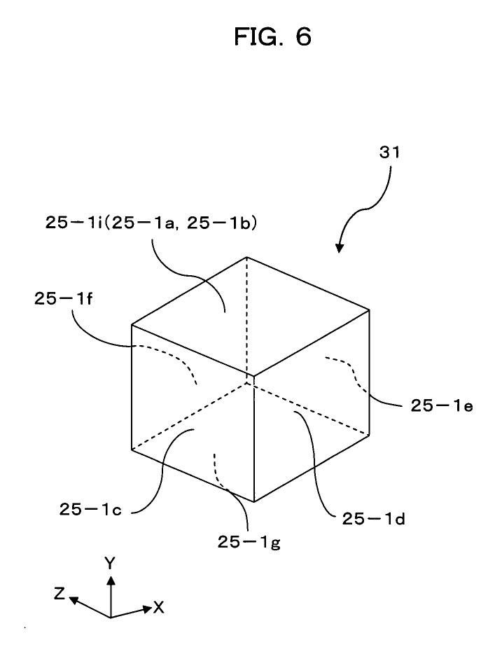

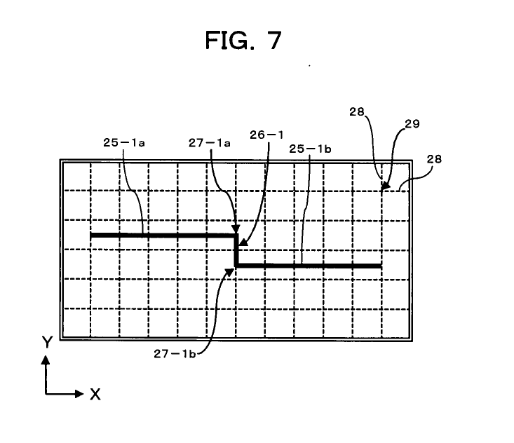

FIG. 2 is a perspective view of a shape model for illustrating the detection process of a micro-step by a step detecting section of the CAD system as the embodiment of the present invention; FIG. 3 is a side view of the shape model for illustrating the detection process of a correction object by a correction object detecting section of the CAD system of the present invention; FIG. 4 is a perspective view of the shape model for illustrating the detection process the correction object by the correction object detecting section of the CAD system of the present invention; FIG. 5 is a side view of a shape model for illustrating the elimination process of a micro-step by a step eliminating section of the CAD system of the present invention; FIG. 6 is a perspective view of the shape model showing a state that the micro-step has been eliminated by the step eliminating section of the CAD system of the present invention; and FIG. 7 is a side view of a shape model showing a state in which an alarm is outputted by an alarm output section thereof.

Here, the wording “grid lines” means a plurality of reference lines formed in a grid pattern on a three-dimensional virtual space. The plurality of reference lines is disposed regularly in the X-axis direction, Y-axis direction and Z-axis direction while keeping a predetermined interval L2 respectively. Also, the predetermined interval L2 (refer to FIG. 3) is set up so as to be identical to the tolerance value. In the embodiment, for example, the predetermined interval L2 is assumed to be set to 0.001 mm.

It should be noted that, FIGS. 3, 5 and 7 each shows the shape model 32 having the three-dimensional shape viewed from one face (side view) and the information in the Z-axis direction (in the depth direction) with respect to the figure is omitted.

The wording “tolerance value” means a threshold value, which is set on the shape model 32 in order to determine whether the end points are jointed or apart from when two end points constituting the shape model 32 are disposed being separated away from each other (not 0). For example, when the tolerance value is set to 1/1000 mm and when the distance between the two end points is 1/1000 mm or less, the CPU 11 determines based on the tolerance value that the two end points are jointed.

The display section 13 is a device for displaying a variety of information about the CAD system 10. For example, the display section 13 displays the shape model 32, contents of the setting information 23 and processing contents of the CAD system 10 and the like. For example, the display section 13 is composed of a CRT (Cathode Ray Tube), an LCD (Liquid Crystal Display), a PDP (Plasma Display Panel) or the like.

The input section 14 is operated by an operator to input various instructions and variety of information to the CPU 11 (CAD system 10) while viewing the display screen image on the display section 13. In the embodiment, the input section 14 is used not only for, for example, inputting the setting information 23 and operating to change or correct the shape of the shape model 32 displayed on the screen of the display section 13 but also for instructing the step detecting section 17, the correction object detecting section 18, the step eliminating section 19 and the alarm output section 24 as described later, to cause them to operate.

In the CAD system 10 according to the embodiment is provided with, for example, a keyboard 33 and a mouse 34 as the input section 14. Information such as numerical value and characters is inputted to the CPU 11 by pressing keys on the keyboard 33; operation amount and operation direction are inputted to the CPU 11 by carrying out drag operation or the like using the mouse 34; information displayed on the screen of the display section 13 is selected and instructions to execute the program are given to the CPU 11 by clicking the mouse.

The memory 15 functions as a working memory or the like when the CPU 11 executes the three-dimensional CAD program 20.

Now, next, various functions achieved by the CPU 11 (functions as the step detecting section 17, the correction object detecting section 18, the step eliminating section 19 and the alarm output section 24) will be described in detail.

Incidentally, in this embodiment, a three-dimensional space, which includes a plurality of construction planes 25-1a to 25-1g and has a substantially cubic shape as shown in FIG. 2 and FIG. 3 is used as the shape model 32. Between the construction plane 25-1a and the construction plane 25-1b in the shape model 32; i.e., on the construction planes 25-1a and 25-1b, a minute plane 26-1 (hereinafter, simply referred to as micro-step) having a dimension smaller than the tolerance value, which is perpendicular to the construction planes 25-1a and 25-1b, is formed.

Hereinafter, description will be made while taking the following case shown in FIG. 3 as an example (hereinafter, occasionally referred to as the relevant model). That is, in these construction planes 25-1a and 25-1b, the construction plane 25-1a is disposed on a grid line 28, the construction plane 25-1b is parallel to the construction plane 25-1a but is not disposed on the grid line 28.

The step detecting section 17 detects a micro-step 26-1, which is smaller than the tolerance value on the respective construction planes 25-1a to 25-1g of the shape model 32 as shown in FIG. 2.

In particular, the step detecting section 17 is adapted to recognize the length of the respective edges constituting the shape model 32, and to detect, in these edges, a portion where is formed with an edge, the length L1 of which is smaller than the tolerance value, as a micro-step 26-1.

The micro-step 26-1 can be detected by using, for example, various existing CAD functions. In addition, in this embodiment, the micro-step is detected by using an existing CAD function, but not limited thereto. The micro-step may be detected by using various kinds of apparatus, programs and the like, which are capable of detecting such micro-step.

The correction object detecting section 18 detects an object portion 30-1 to be corrected in the shape model 32 based on the positional relationship between the end portions 27-1a and 27-1b constituting the micro-step 26-1, which is detected by the step detecting section 17, and an intersection 29 of the grid lines 28 as shown in FIG. 3.

For example, in the case where the model is the object to be corrected, an end portion (in the example shown in FIG. 3, end portion 27-1b) among the end portions 27-1a and 27-1b constituting the micro-step 26-1, which is not positioned on the intersection 29 of the grid lines 28, is detected based on the respective coordinate values of the end portions 27-1a and 27-1b constituting the micro-step 26-1. And the construction plane 25-1b including the end portion 27-1b is detected as the object portion 30-1 to be corrected as shown in FIG. 3 and FIG. 4.

In particular, the correction object detecting section 18 is adapted to determine an end portion, in which at least any one of the values X, Y and Z is not integral multiple of the tolerance value (in the example shown in FIG. 3, the end portion 27-1b) as the end portion, which is not located on the intersection 29 of the grid lines 28, based on the coordinate values (X, Y, Z) of the respective end portions 27-1a and 27-1b. Then, the construction plane 25-1b, which includes the end portion 27-1b, is detected as the object portion 30-1 to be corrected.

For example, in the case where the tolerance value is set to 0.001 mm and when any one of the coordinate values of the end portion is “10.002” or “10.003”, the end portion is determined as located on an intersection 29 of the grid lines 28. In the case where the tolerance value is set to 0.002 mm and when any one of the coordinate values of the end portion is “10.001” or “10.0025”, the end portion is determined as not located on the intersection 29 of the grid lines 28.

Here, an end portion located on the intersection 29 of the grid lines 28 implies that a segment constituting the end portion in the three-dimensional space overlaps with a grid line 28. It should be noted that, however, in the example shown in FIG. 3, since the Z-axis direction is omitted from the figure, when an end portion is not located on any grid lines 28 in the X or Y-axis direction, it is referred to as “the end portion is not located on the intersection 29 of the grid lines 28”.

Hereinafter, such description that end portion is not located on the intersection 29 of any grid lines 28 indicates that a segment constituting the end portions in the three-dimensional space does not overlap with any grid line 28.

It should be noted that, in this model, the construction plane 25-1a is disposed on the grid line 28 as described above, and the construction plane 25-1b is parallel to the construction plane 25-1a but is not disposed on any grid line 28. Therefore, the other end portion 27-1c with respect to the end portion 27-1b is not positioned on the intersection 29 of the grid lines 28.

The step eliminating section 19 eliminates the micro-step 26-1 on the construction planes 25-1a and 25-1b of the shape model 32 by changing the shape of the shape model 32 relevant to object portion 30-1 to be corrected, which is detected by the correction object detecting section 18.

For example, when the model is the object to be corrected, the step eliminating section 19 replaces the object portion 30-1 to be corrected with a plane 25-1h located on the same plane as that of the construction plane 25-1a, which is different from the plane of the object portion 30-1 to be corrected in the construction planes 25-1a and 25-1b constituting the micro-step 26-1, as shown FIG. 5; thereby the micro-step 26-1 on the construction planes 25-1a and 25-1b of the shape model 32 is eliminated.

In particular, the construction plane 25-1b, which is detected as the object portion 30-1 to be corrected, is shifted (offset) in the Y-axis direction as shown in FIG. 5; thereby the construction plane 25-1b is replaced with a new construction plane 25-1h located on the same plane as that of the construction plane 25-1a. Thus, the construction plane 25-1a and the construction plane 25-1h form one construction plane 25-1i and construct the shape model 31 having the construction planes 25-1c, 25-1d, 25-1e, 25-1f, 25-1g and 25-1i (refer to FIG. 6).

The above replacement can be achieved by using, for example, various existing CAD functions such as offset function of a plane. It should be noted that, in this embodiment, the object portion to be corrected is replaced by using a plane-offset function as an existing CAD function, but is not limited to the above. Various apparatus, programs and the like, which are capable of replacing plane may be employed.

The alarm output section 24 outputs an alarm when the end portions 27-1a and 27-1b constituting the micro-step 26-1 detected by the step detecting section 17 are located at an undesirable position with respect to an intersection 29 of the grid lines 28 as shown in FIG. 1.

The wording “undesirable position” means a state that, for example, the construction planes 25-1a and 25-1b are disposed parallel to each other along the grid lines 28, but both of the end portions 27-1a and 27-1b constituting the micro-step 26-1 are not located on the intersection 29 of the grid lines 28 as shown in FIG. 7.

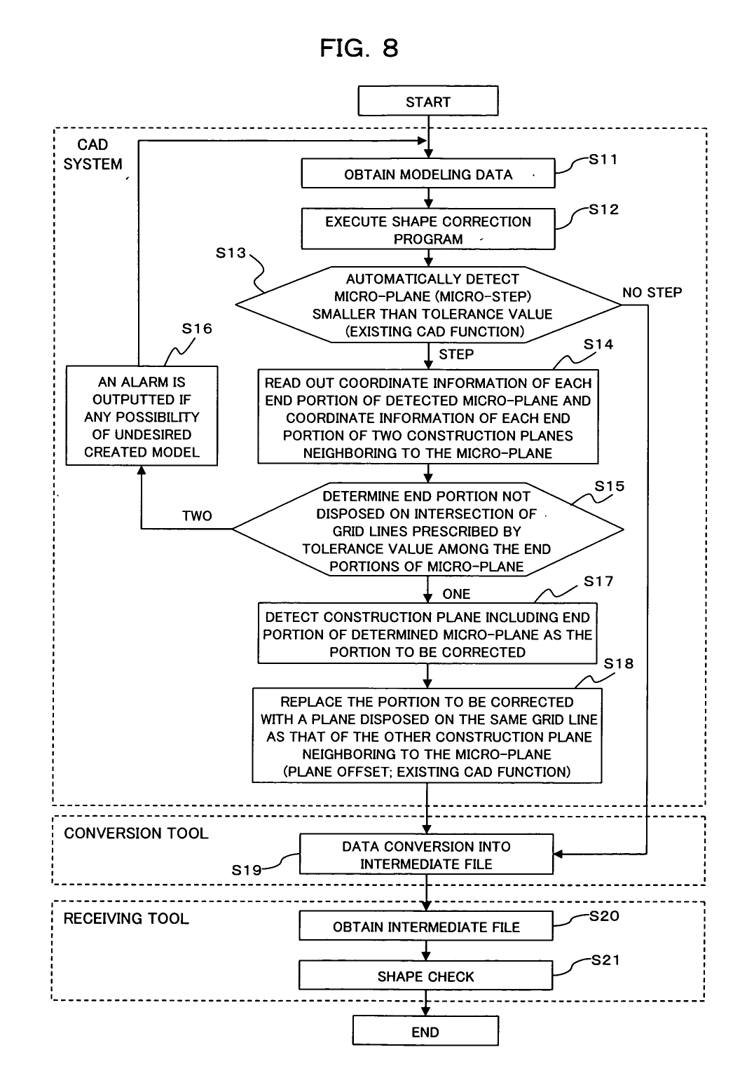

The shape correcting technique of a shape model in the CAD system 10 according to one embodiment of the present invention, which is configured as described above, will be described taking the above-described case of eliminating micro-step of the model as an example in accordance with a flowchart shown in FIG. 8 (step S11 to S21).

The CAD system 10 according to the embodiment is adapted so as to perform the processing from step S11 to S18 as described below.

First of all, the CAD system 10 obtains modeling data 22 relevant to the shape model 32 (step S11). As for the modeling data 22, for example, modeling data, which has been created/changed by an operator such as a designer using the three-dimensional CAD program 20 or other system (hereinafter, occasionally referred to as “writing side”), is used.

Then, when the operator executes the shape correction program 21 stored in the CAD system 10 (step S12), the step detecting section 17 detects (automatically detects) a minute plane (micro-step 26-1), which is smaller than the tolerance value, in the shape model 32 (step S13; step detecting step).

When no micro-step (minute plane) 26-1 is detected in the shape model 32 (refer to “NO STEP” route in step S 13), the conversion tool converts the three-dimensional modeling data 22 into an intermediate file (step S19).

On the other hand, any micro-step 26-1 is detected in the shape model 32 (refer to “STEP” route in step S13), the correction object detecting section 18 reads out the coordinate information of each of the end portions 27-1a and 27-1b of the detected micro-step 26-1 and the coordinate information of each of the end portions 27-1a, 27-1b, 27-1c and 27-1d of the two construction planes 25-1a and 25-1b neighboring to the micro-step 26-1 (step S14).

The correction object detecting section 18 identifies the end portion 27-1b, which is not disposed on the intersection 29 of the grid lines 28 defined by the tolerance value, based on the coordinate information of each of the end portions 27-1a and 27-1b of the read out micro-step 26-1 and counts the number thereof (step S15).

When the number of the identified end portions of the micro-step, which are not located on the intersection 29 of the grid lines 28, is two (refer to “TWO” route in step S15), the alarm output section 24 outputs an alarm to alarm that the state of the created model may be undesirable (step S16). When the minute plane constituting the micro-step has a complicated shape, and there are included, for example, three or more identified end portions of the micro-step, which are not located on the intersection 29 of the grid lines 28, the alarm output section 24 outputs an alarm when the end portions of the micro-step are two or more.

On the other hand, when the number of the identified end portions of a micro-step that is not located on the intersection 29 of the grid lines 28 is only one (refer to “ONE” route in step S15), the correction object detecting section 18 detects the construction plane 25-1b, which includes the end portion 27-1b of the identified micro-step, as the object portion 30-1 to be corrected (step S17; correction object detecting step).

The step eliminating section 19 replaces the detected object portion 30-1 to be corrected with the plane 25-1h, which is disposed on the same grid line 28 as that of the other construction plane 25-1a neighboring to the micro-step 26-1 to eliminate the micro-step 26-1 (steps 18; step eliminating step). In particular, the replacement of the plane is made by using, for example, a “plane offset” function, which is an existing CAD function.

As described above, when the step eliminating section 19 replaces the object portion 30-1 to be corrected with the plane 25-1h, the shape of the shape model 32 is changed into the shape model 31, which does not include the micro-step 26-1.

The three-dimensional modeling data 22 relevant to the shape model 31, from which the micro-step 26-1 has been eliminated, is transferred to the receiving side tool after being converted into an intermediate file by the conversion tool (step S19).

Then, the receiving side tool receives the intermediate file transferred from the conversion tool (step S20), and the shape of the shape model 31 is checked (step S21), thus the processing is completed.

As described above, according to the CAD system 10 as an embodiment of the present invention, the micro-step 26-1, which is smaller than the tolerance value, is detected on the construction planes 25-1a and 25-1b of the shape model 32 first. Then, the object portion 30-1 to be corrected in the shape model 32 is detected, and the shape of the shape model 32 relevant to the object portion 30-1 to be corrected is changed, thereby the micro-step 26-1 is eliminated. Accordingly, the step to detect and eliminate the micro-step 26-1, which has been conventionally carried out by an operator, can be eliminated, and the working load therefor can be reduced.

Therefore, in particular, when many micro-steps 26-1 smaller than the tolerance value are included in the shape model 32, the working load on the operator can be largely reduced.

Moreover, it is not necessary for the designer or the like to manually correct the shape of the shape model 32. Accordingly, the number of works for exchanging the three-dimensional modeling data 22 relevant to the shape model 32 can be reduced.

Moreover, the shape of the shape model 32 relevant to the detected object portion 30-1 to be corrected is changed, and the micro-step 26-1 on the construction planes 25-1a and 25-1b of the shape model 32 is eliminated. Accordingly, the three-dimensional modeling data 22 free from the data of micro-step 26-1 or the like smaller than the tolerance value can be generated.

That is, since the micro-step 26-1 itself is eliminated from the shape model 32, for example, even when the shape model 32 is handled with a tool, which handles the tolerance value in a different manner afterward, no problem caused from the micro-step 26-1 will occur. Accordingly, the convenience is increased.

Moreover, the end portion 27-1b of the end portions 27-1a and 27-1b constituting the micro-step 26-1, which is not located on the intersection 29 of the grid lines 28, is detected first, and the construction plane 25-1b including the end portion 27-1b is detected as the object portion 30-1 to be corrected. Therefore, the construction plane 25-1b as a cause to generate the micro-step 26-1 can be detected easily and precisely. Accordingly, the object portion 30-1 to be corrected can be detected swiftly.

Moreover, the object portion 30-1 to be corrected is detected based on the coordinate values of the end portion 27-1b constituting the micro-step 26-1. Accordingly, the end portion 27-1b as a cause to generate the micro-step 26-1 can be detected swiftly and precisely.

Moreover, the step eliminating section 19 replaces the object portion 30-1 to be corrected with a plane, which coincides with the construction plane 25-1a different from the object portion 30-1 to be corrected in the construction planes 25-1a and 25-1b constituting the micro-step 26-1, thereby the micro-step 26-1 on the construction planes 25-1a and 25-1b of the shape model 32 is eliminated. Accordingly, particularly, the micro-step 26-1 on the shape model 32 having a cubic shape can be eliminated easily and precisely.

Moreover, when the end portions 27-1a and 27-1b constituting the micro-step 26-1 detected by the step detecting section 17 are located at undesirable positions with respect to the intersection 29 of the grid lines 28, an alarm is outputted. Accordingly, it is possible to recognize that the shape model 32 includes a portion of inconsistency in its data. Therefore, the quality of design can be increased, and it is possible for the designer or the like to recognize that the micro-step cannot be eliminated. Accordingly, the data conversion error can be prevented when exchanging the three-dimensional modeling data 22 relevant to the shape model 32.

### [2] Others

Note that, the present invention is not limited to the above-described embodiment but may be implemented while adding various modifications within a range of the spirit thereof.

For example, the correction object detecting section 18 and the step eliminating section 19 are adapted to handle various kinds of shape models as the object in addition to the above-described model.

However, it should be noted that functions of the correction object detecting section 18 and the step eliminating section 19 might be different from the case that the above-described model is handled as the object depending on the conditions on which the micro-step is formed.

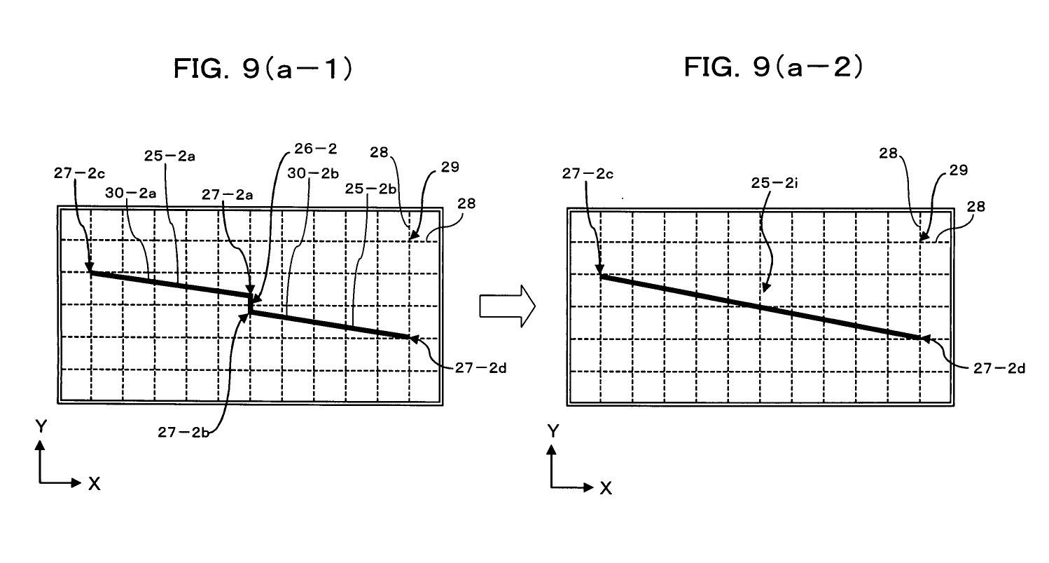

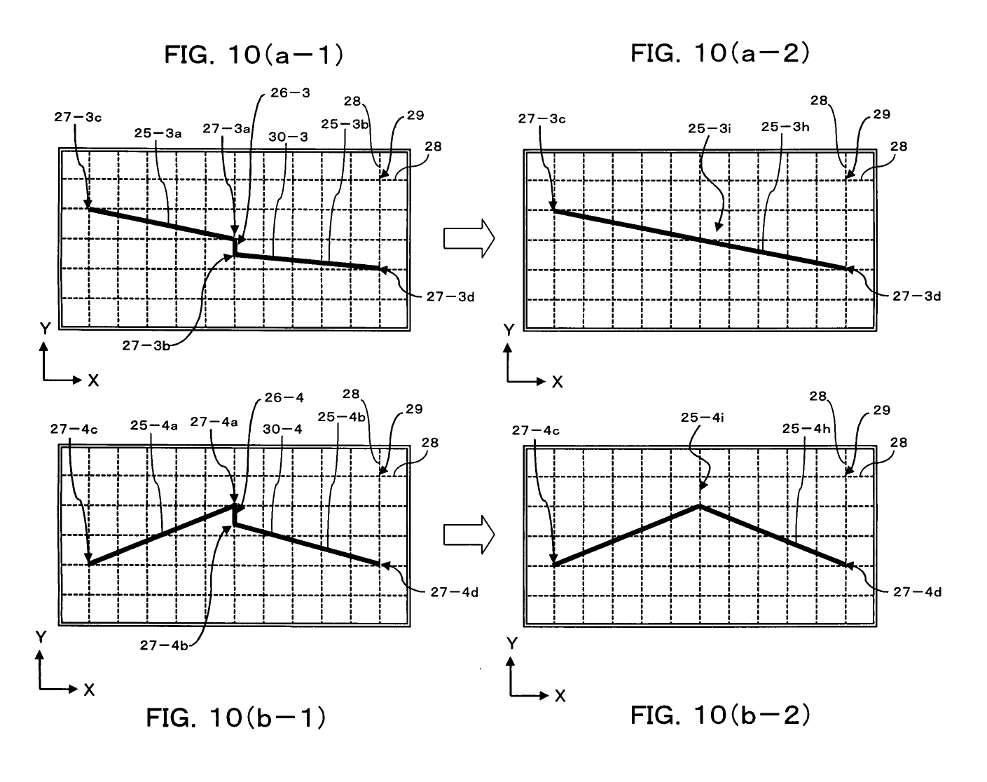

Hereinafter, techniques to eliminate a micro-step on a shape model other than the above-described model with the correction object detecting section 18 and the step eliminating section 19 will be described taking a model A and a model B as an example with reference to FIG. 9 and FIG. 10.

FIG. 9(a-1) is a side view of a shape of a model A for illustrating a detection process of the correction object with the correction object detecting section in the CAD system according to the present invention; and FIG. 9(a-2) is the side view of the shape of the model A for illustrating the elimination process of the micro-step with the step eliminating section in the CAD system of the present invention. FIG. 10(a-1) is a side view of a shape of a model B for illustrating a detection process of a correction object with the correction object detecting section in the CAD system of the present invention; and FIG. 10(a-2) is a side view of the shape of the model B for illustrating the elimination process of the micro-step with the step eliminating section in the CAD system of the present invention. FIG. 10(b-1) is a side view of the shape of the model B for illustrating the detection process of the correction object with the correction object detecting section in the CAD system of the present invention; and FIG. 10(b-2) is a side view of the shape of the model B for illustrating the elimination process of the micro-step with the step eliminating section in the CAD system of the present invention.

It should be noted that FIGS. 9 and 10 show a state of the shape model, which has a three-dimensional shape, viewed from one face of the (side view) respectively; and information in the Z-axis direction (depth direction) in the figure is omitted and only the portion relevant to the micro-step is picked up for convenience.

### (2-1) When the Model a is the Object to be Corrected

The model A in the following conditions will be described. That is, as shown in FIG. 9(a-1), a micro-step 26-2 is formed on construction planes 25-2a and 25-2b disposed diagonally with respect to the grid line 28; among the end portions in these construction planes 25-2a and 25-2b, the end portions 27-2a and 27-2b at a side where the micro-step 26-2 exists are not located on the intersection 29 of the grid lines 28; and the end portions 27-2c and 27-2d at the sides opposite to the micro-step 26-2 are located on an intersection 29 of the grid lines 28 respectively.

When the model A is the object to be corrected, the correction object detecting section 18 detects the end portions 27-2a and 27-2b, which are not located on the intersection 29 of the grid lines 28, based on the coordinate values of the end portions 27-2a and 27-2b constituting the micro-step 26-2 as shown in FIG. 9(a-1). The construction planes 25-2a and 25-2b including the end portions 27-2a and 27-2b are detected as the object portions to be corrected 30-2a and 30-2b.

In addition, the step eliminating section 19 is adapted to replace the plurality of construction planes 25-2a and 25-2b including the object portions 30-2a and 30-2b to be corrected with a construction plane 25-2i, which does not include the micro-step 26-2, as shown in FIG. 9(a-2), thereby the micro-step 26-2 on the construction planes 25-2a and 25-2b of the shape model is eliminated.

In particular, the step eliminating section 19 is adapted to replace the construction planes 25-2a and 25-2b, which are detected as the object portions 30-2a and 30-2b to be corrected, with a new construction plane 25-2i including the end portions 27-2c and 27-2d on the same plane, which are located at the opposite sides of the micro-step 26-2 in the construction planes 25-2a and 25-2b as shown in FIG. 9(a-2). The above processing can be achieved by utilizing, for example, various existing CAD functions such as a plane offset function.

### (2-2) When the Model B is the Object to be Corrected

Next, a description will be made about the model B, in which a micro-step 26-3 is formed on construction planes 25-3a and 25-3b disposed at an angle with respect to the grid lines 28 as shown in FIG. 10(a-1); and further, an end portion 27-3b at the micro-step 26-2 side in one construction plane 25-3b is not positioned on the intersection 29 of the grid lines 28; and each of the other end portions 27-3a, 27-3c and 27-3d is positioned on the intersection 29 of the grid lines 28.

When the model B is the object to be corrected, the correction object detecting section 18 detects, as shown in FIG. 10(a-1), the end portion 27-3b, which is not positioned on the intersection 29 of the grid lines 28, based on the coordinate values of the end portions 27-3a and 27-3b constituting the micro-step 26-3, and detects the construction plane 25-3b including the end portion 27-3b as an object portion 30-3 to be corrected.

Also, the step eliminating section 19 replaces the object portion 30-3 to be corrected with a plane 25-3h, which coincides with the construction plane 25-3a that is different from the object portion 30-3 to be corrected among the construction planes 25-3a and 25-3b constituting the micro-step 26-3, and thereby eliminates the micro-step 26-3 on the construction planes 25-3a and 25-3b of the shape model.

In particular, the construction plane 25-3b detected as the object portion 30-3 to be corrected is replaced with the new construction plane 25-3h, which is the same plane as the construction plane 25-3a as shown in FIG. 10(a-1) and FIG. 10(a-2), and thereby a new construction plane 25-3i, which includes the end portions 27-3c and 27-3d at the opposite sides of the micro-step 26-3 in the construction planes 25-3a and 25-3b, is formed.

Moreover, in the case other than the model B, even in such a case that each of the construction planes constituting a micro-step is disposed at an angle with respect to the grid lines 28, one end portion at the micro-step side is not positioned on the intersection 29 of the grid lines 28, but the other end portions are positioned on the intersections 29 of the grid lines 28, the correction object detecting section 18 and step eliminating section 19 are adapted to function in the same manner as described above.

For example, in such a case, as shown in FIG. 10(b-1) and FIG. 10(b-2), that a micro-step 26-4 is formed at an apex between the construction planes 25-4a and 25-4b disposed to form a nearly “<”-like shape viewed from the side; an end portion 27-4b at the micro-step 26-4 side in one construction plane 25-4b is not positioned on the intersection 29 of the grid lines 28; but each of the other end portions 27-4a, 27-4c and 27-4d is positioned on the intersections 29 of the grid lines 28, same as that of the above-described model B, the correction object detecting section 18 detects the construction plane 25-4b including the end portion 27-4b, which is not positioned on the intersection 29 of the grid lines 28, as an object portion to be corrected 30-4. Then, the step eliminating section 19 replaces the construction plane 25-4b, which is detected as the object portion 30-4 to be corrected, with a new construction plane 25-4h including the end portion 27-4a of the construction plane 25-4a and the end portion 27-4b of the construction plane 25-4b; thereby a new construction plane 25-4i having a nearly “<”-like shape viewed from the side is formed.

In the above-described embodiments, the descriptions have been made about such cases that the construction planes constituting the micro-step are flat planes. However, the present invention is not limited to the above, but is applicable to a case such that construction planes constituting the micro-step are curved planes.

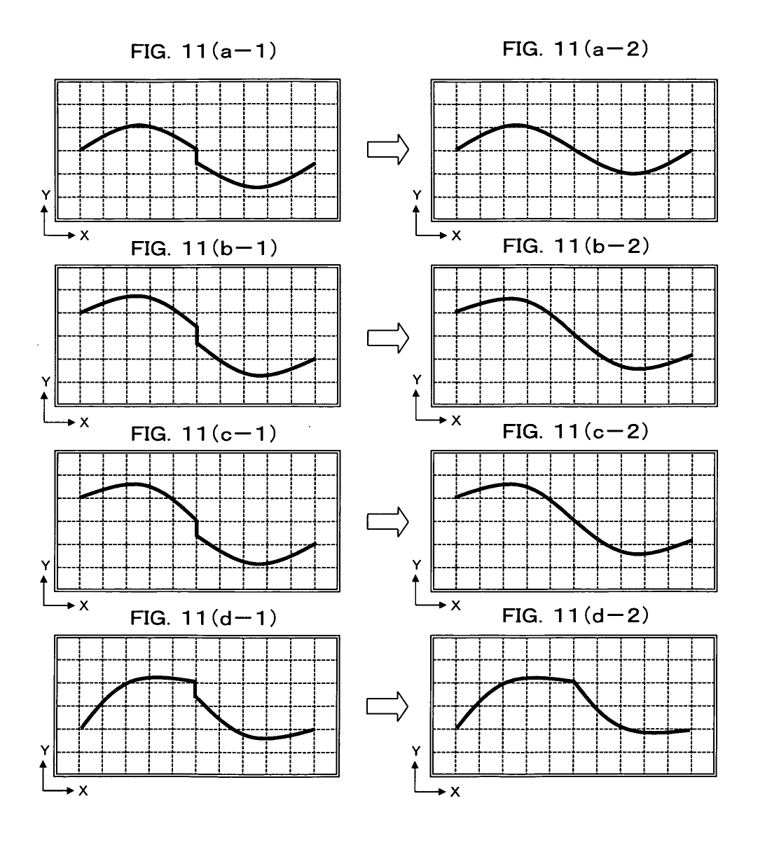

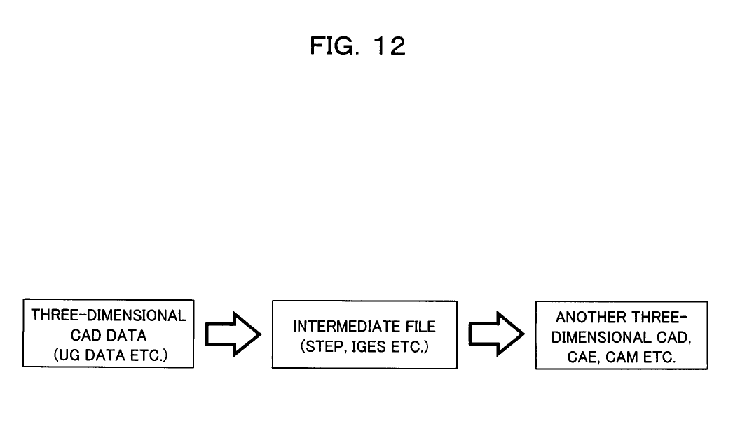

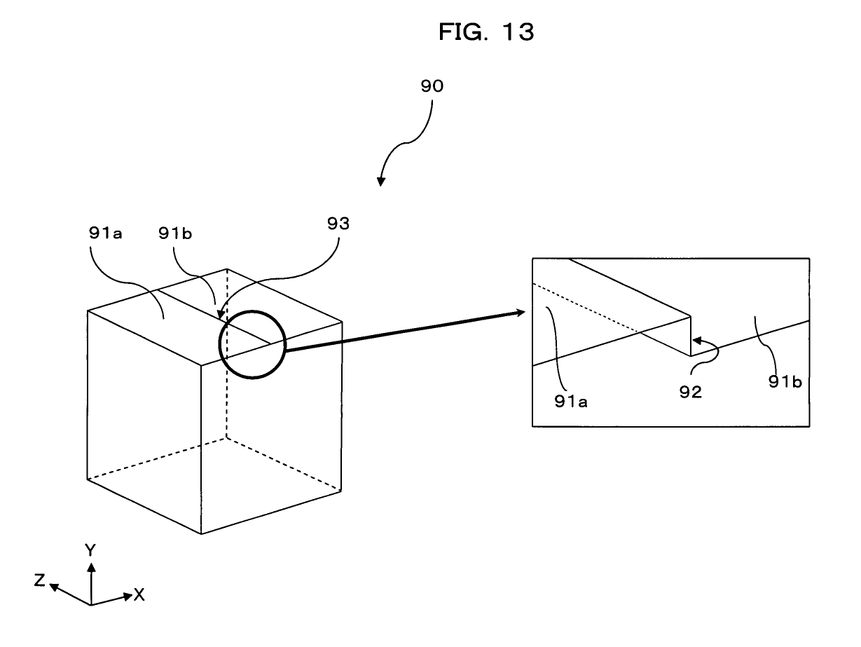

FIGS. 11(a-1), 11(b-1), 11(c-1) and 11(d-1) are side views of shape models each illustrating a process to detect a correction object by the correction object detecting section in the CAD system according to the present invention. FIGS. 11(a-2), 11(b-2), 11(c-2) and 11(d-2) are side views of shape models each illustrating the process to eliminate the micro-step by the step eliminating section in the CAD system according to the present invention.

It should be noted that, the FIGS. 11(a-1) to 11(d-1) and FIGS. 11(a-2) to 11(d-2) show a shape model respectively, which has a three-dimensional shape, in a state viewed from the side (side view) and information about the Z-axis direction with respect to the space (in the depth direction with respect to the space) is omitted therefrom, and only a portion relevant to the micro-step is picked up for convenience.

For example, in the micro-step shown in FIG. 11(a-1), the correction object detecting section 18 and the step eliminating section 19 perform the same processing as the above-described case in which the relevant model is processed as the object to eliminate the micro-step as shown in FIG. 11(a-2).

Also, in the micro-step shown in FIG. 11(b-1), the correction object detecting section 18 and the step eliminating section 19 performs the same processing as the above-described case in which the model A is processed as the object to eliminate the micro-step as shown in FIG. 11(b-2).

Further, in the micro-steps shown in FIG. 11(c-1) and FIG. 11(d-1), the correction object detecting section 18 and the step eliminating section 19 perform the same processing as the above-described case in which the model B is processed as the object to eliminate the micro-step as shown in FIG. 11(c-2) and FIG. 11(d-2).

It should be noted that, the processing might be carried out so that the curvatures of the respective construction planes are changed to eliminate the micro-step; or, each of the construction planes constituting the micro-step may be a combination of a flat plane and a curved plane.

Also, the above-described embodiments have been described using a three-dimensional CAD system. However, the present invention is not limited the above, but a two-dimensional CAD system may be used.

Further, in the above-described embodiments, the shape correction program 21 is stored in the HDD 12 separated from the three-dimensional CAD program 20. However, the present invention is not limited to the above, but a part or whole of the shape correction program 21 may be incorporated into the above-described three-dimensional CAD program 20.

Furthermore, the above-described three-dimensional CAD program 20 and the shape correction program 21 may be provided in such a manner, for example, that the programs are stored on a computer-readable storage medium such as a flexible disk, CD-ROM or the like. Then the CAD system 10 reads out the three-dimensional CAD program 20 and the shape correction program 21 from the storage medium, and transfers the same to the HDD 12 to store the same therein. And the programs may be stored in storage (storage medium) such as, for example, a magnetic disk, optical disk, magnetic optical disk or the like, and may be provided to the CAD system 10 through a communication channel from the storage.

Note that, each of the above-described functions as the step detecting section 17, the correction object detecting section 18, the step eliminating section 19 and the alarm output section 24 in the CAD system 10 may be realized by a computer (including a CPU, an information processing unit and various terminals), which executes a predetermined application program (the shape correction program 21 in the CAD system 10).

The programs may be provided in a mode being recorded on a computer-readable storage medium such as, for example, a flexible disk, a CD (CD-ROM, CD-R, CD-RW or the like), a DVD (DVD-ROM, DVD-RAM, DVD-R, DVD-RW, DVD+R, DVD+RW or the like). In this case, the computer reads out the shape correction program 21 from the storage medium and transfers the program to internal storage or external storage to store and use the program. Also, the program may be stored in storage (storage medium) such as, for example, a magnetic disk, an optical disk and a magnetic optical disk, and the program may be provided to the computer from the storage through a communication line.

Here, the wording “computer” is a concept including hardware and an OS, and means hardware, which operates under a control of the OS. Also, in the case when the hardware is caused to operate only by the application program without using the OS, the hardware itself is equivalent to the computer. The hardware is equipped with at least a microprocessor such as a CPU and means for reading out the computer program stored in the storage medium.

The above-described application program as the shape correction program 21 of the CAD system 10 includes program codes for causing the above-described computer to realize the functions as the step detecting section 17, the correction object detecting section 18, the step eliminating section 19 and the alarm output section 24 in the CAD system 10. Furthermore, the OS may realize a part of the functions without using the application program.

As for the storage medium as the embodiment of the present invention, in addition to the above-described flexible disk, CD, DVD, magnetic disk, optical disk, magnetic optical disk, various kinds of computer-readable media such as an IC card, ROM cartridge, magnetic tape, punch card, internal storage (memory such as a RAM and ROM) of the computer, external storage, a printed item with codes such as barcodes may be utilized.

What is claimed is:

1. A CAD system handling a shape model on a virtual space in which a plurality of reference lines is formed in a grid pattern keeping a predetermined interval, the predetermined interval being set so as to be identical to a tolerance value set in the shape model, said CAD system comprising:
a step detecting section for detecting a micro-step smaller than the tolerance value on a construction plane of the shape model;
a correction object detecting section for detecting an object portion to be corrected in the shape model based on a positional relationship between an end portion constituting the micro-step detected by the step detecting section and an intersection of said reference lines disposed in a grid pattern; and
a step eliminating section for eliminating a micro-step on the construction plane of said shape model by changing the shape of the shape model relevant to the object portion to be corrected detected by the correction object detecting section.

2. The CAD system according to claim 1, wherein the correction object detecting section detects an end portion, which is not positioned on the intersection of said reference lines disposed in a grid pattern, among the end portions constituting said micro-step, and detects the construction plane including the relevant end portion as the object portion to be corrected.

3. The CAD system according to claim 2, wherein the correction object detecting section detects an end portion, which is not positioned on the intersection of said reference lines disposed in a grid pattern based on coordinate values of the end portion constituting said micro-step and detects the construction plane including the relevant end portion as the object portion to be corrected.

4. The CAD system according to claim 1, wherein the step eliminating section replaces the object portion to be corrected with a plane which coincides with a portion different from the relevant object portion to be corrected among the portions constituting said micro-step, and thereby eliminates the micro-step on the construction plane of said shape model.

5. The CAD system according to claim 1, wherein the step eliminating section replaces a plurality of portions including the object portion to be corrected with portions not including the micro-step, and thereby eliminates the micro-step on the construction plane of said shape model.

6. The CAD system according to claim 1, further comprising an alarm output section for outputting an alarm when the end portion constituting the micro-step detected by said step detecting section is located at an undesirable position with respect to the intersections of said reference lines disposed in a grid pattern.

7. A shape correcting method of a shape model disposed on a virtual space in which a plurality of reference lines is formed in a grid pattern keeping a predetermined interval set so as to be identical to a tolerance value, said method comprising:
a step detecting step detecting a micro-step smaller than the tolerance value on a construction plane of the shape model;
a correction object detecting step detecting an object portion to be corrected in the shape model based on a positional relationship between an end portion constituting the micro-step detected in the step detecting step and an intersection of said reference lines disposed in a grid pattern; and
a step eliminating step eliminating the micro-step on the construction plane of said shape model by changing the shape of the shape model relevant to the object portion to be corrected detected in the correction object detecting step.

8. The shape correcting method according to claim 7, wherein, in the correction object detecting step, an end portion which is not positioned on the intersection of said reference lines disposed in a grid pattern among the end portions constituting said micro-step is detected, and a construction plane including the relevant end portion is detected as the object portion to be corrected.

9. The shape correcting method according to claim 8, wherein, in the correction object detecting step, an end portion which is not positioned on the intersection of said reference lines disposed in a grid pattern is detected based on coordinate values of the end portion constituting said micro-step, and the construction plane including the relevant end portion is detected as the object portion to be corrected.

10. The shape correcting method according to claim 7, wherein, in the step eliminating step, the object portion to be corrected is replaced with a plane which coincides with a portion different from the relevant object portion to be corrected among the portions constituting said micro-step, and thereby the micro-step on the construction plane of said shape model is eliminated.

11. The shape correcting method according to claim 7, wherein, in the step eliminating step, a plurality of portions including the object portion to be corrected is replaced with portions not including the micro-step, and thereby the micro-step on the construction plane of said shape model is eliminated.

12. The shape correcting method according to claim 7, further comprising an alarm outputting step outputting an alarm when the end portion constituting the micro-step detected in said step detecting step is located at an undesirable position with respect to the intersections of said reference lines disposed in a grid pattern.

13. A computer-readable storage medium having a shape correction program recorded thereon causing a computer to execute a shape correction function of a shape model disposed on a virtual space, in which a plurality of reference lines is formed in a grid pattern keeping a predetermined interval set so as to be identical to a tolerance value,
the shape correction program causing the computer to execute:
a step detecting step detecting a micro-step smaller than the tolerance value on a construction plane of the shape model;
a correction object detecting step detecting an object portion to be corrected in the shape model based on a positional relationship between an end portion constituting the micro-step detected in the step detecting step and an intersection of said reference lines disposed in a grid pattern; and
a step eliminating step eliminating the micro-step on the construction plane of said shape model by changing the shape of the shape model relevant to the object portion to be corrected detected in the correction object detecting step.

14. The computer-readable storage medium having the shape correction program recorded thereon according to claim 13, the shape correction program, when causing the computer to execute the correction object detecting step, allowing the computer to realize a function of detecting an end portion which is not positioned on the intersection of said reference lines disposed in a grid pattern among the end portions constituting said micro-step, and detecting a construction plane including the relevant end portion as the object portion to be corrected.

15. The computer-readable storage medium having the shape correction program recorded thereon according to claim 14, the shape correction program, when causing the computer to execute the correction object detecting step, allowing the computer to realize a function of detecting an end portion which is not positioned on the intersection of said reference lines disposed in a grid pattern based on coordinate values of the end portion constituting said micro-step, and detecting the construction plane including the relevant end portion as the object portion to be corrected.

16. The computer-readable storage medium having the shape correction program recorded thereon according to claim 13, the shape correction program, when causing the computer to execute the step eliminating step, allowing the computer to realize a function of replacing the object portion to be corrected with a plane which coincides with a portion different from the relevant object portion to be corrected among the portions constituting said micro-step, and thereby eliminating the micro-step on the construction plane of said shape model.

17. The computer-readable storage medium having the shape correction program recorded thereon according to claim 13, the shape correction program, when causing the computer to execute the step eliminating step, allowing the computer to realize a function of replacing a plurality of portions including the object portion to be corrected with portions not including the micro-step, and thereby eliminating the micro-step on the construction plane of said shape model.

18. The computer-readable storage medium having the shape correction program recorded thereon according to claim 13, the shape correction program causing the computer to execute an alarm outputting step outputting an alarm when the end portion constituting the micro-step detected in said step detecting step is located at an undesirable position with respect to the intersections of said reference lines disposed in a grid pattern.
